(19) United States
(12) Patent Application Publication
(10) Pub. No.: US 2026/0091511 A1
(43) Pub. Date: Apr. 2, 2026

(54) CLAMPING DEVICE

(71) Applicant: PASCO PRECISION CORP., Tainan City (TW)

(72) Inventor: Chih-Ching LIN, Tainan City (TW)

(21) Appl. No.: 19/240,425

(22) Filed: Jun. 17, 2025

(30) Foreign Application Priority Data
Oct. 1, 2024 (TW) 113137603

(51) Int. Cl. B25J 15/02; B25B 11/00

(52) U.S. Cl. CPC B25J 15/022; B25B 11/00

(57) ABSTRACT

A clamping device includes a seat mechanism, an operating unit, and a clamping mechanism. The clamping mechanism includes a movable seat connected to the operating unit and clamping units. The clamping units are connected to the seat mechanism and the movable seat. Each clamping unit has a clamping portion. The operating unit is operable for driving the clamping mechanism to move relative to the seat mechanism between a release position and a clamping position. During movement of the clamping mechanism from the release position to the clamping position, the movable seat is moved relative to the seat mechanism, thereby driving the clamping portions of the plurality of clamping units to move toward each other to clamp a disc-shaped object.

### CROSS-REFERENCE TO RELATED APPLICATION

This application claims priority to Taiwanese Invention Patent Application No. 113137603, filed on Oct. 1, 2024, the entire disclosure of which is incorporated by reference herein.

### FIELD

The disclosure relates to a clamping device, and more particularly to a clamping device adapted for clamping a disc-shaped object.

### BACKGROUND

Chemicals are commonly used during manufacturing of products. The chemicals may remain on the fixtures and the devices used in the manufacturing of products. A user has to wear protective gloves when picking up the fixtures and the devices that are disc-shaped. However, in the case where the protective gloves are damaged, the user's hands may be exposed to the chemicals, thereby causing safety hazards.

### SUMMARY

Therefore, an object of the disclosure is to provide a clamping device that can alleviate at least one of the drawbacks of the prior art.

According to the disclosure, the clamping device is adapted for clamping a disc-shaped object, and includes a seat mechanism, an operating unit, and a clamping mechanism.

The operating unit is disposed on the seat mechanism.

The clamping mechanism includes a movable seat and a clamping module. The movable seat has an installation portion disposed under and spaced apart from the seat mechanism, and a shaft portion extending upwardly through the seat mechanism. The movable seat is connected to the operating unit. The clamping module includes a plurality of clamping units pivotally connected to the seat mechanism and the movable seat. The plurality of clamping units are angularly spaced apart from each other and extend outwardly from the movable seat. Each of the plurality of clamping units has a clamping portion that is distal from the movable seat.

The operating unit is operable for driving the clamping mechanism to move relative to the seat mechanism between a release position, where the clamping units are adapted to release the disc-shaped object therefrom, and a clamping position, where the clamping units are adapted to clamp the disc-shaped object.

During movement of the clamping mechanism from the release position to the clamping position, the movable seat is moved upwardly relative to the seat mechanism, thereby driving the clamping portions of the plurality of clamping units to move toward each other to clamp the disc-shaped object.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view illustrating a clamping device according to an embodiment of the disclosure.

FIG. 2 is a perspective view of the embodiment illustrating the clamping device from another angle.

FIG. 3 is an exploded perspective view of the embodiment illustrating a seat mechanism, an operating unit, and a clamping mechanism of the clamping device.

FIG. 4 is a fragmentary exploded perspective view of the embodiment illustrating a fixed seat and the clamping mechanism of the clamping device.

FIG. 5 is a schematic sectional view of the embodiment illustrating the clamping mechanism in a release position.

FIG. 6 is a schematic sectional view of the embodiment illustrating the clamping mechanism in a clamping position for clamping a disc-shaped object.

FIG. 7 is an enlarged schematic sectional view of the embodiment illustrating the operating unit, the fixed seat, a movable seat, and clamping units of a clamping module during movement of the clamping mechanism from the release position to the clamp position.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

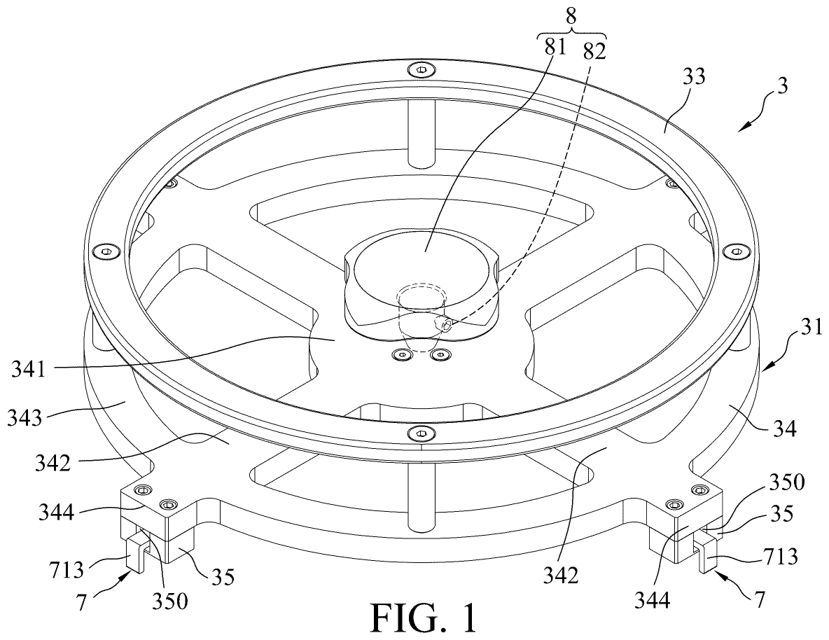

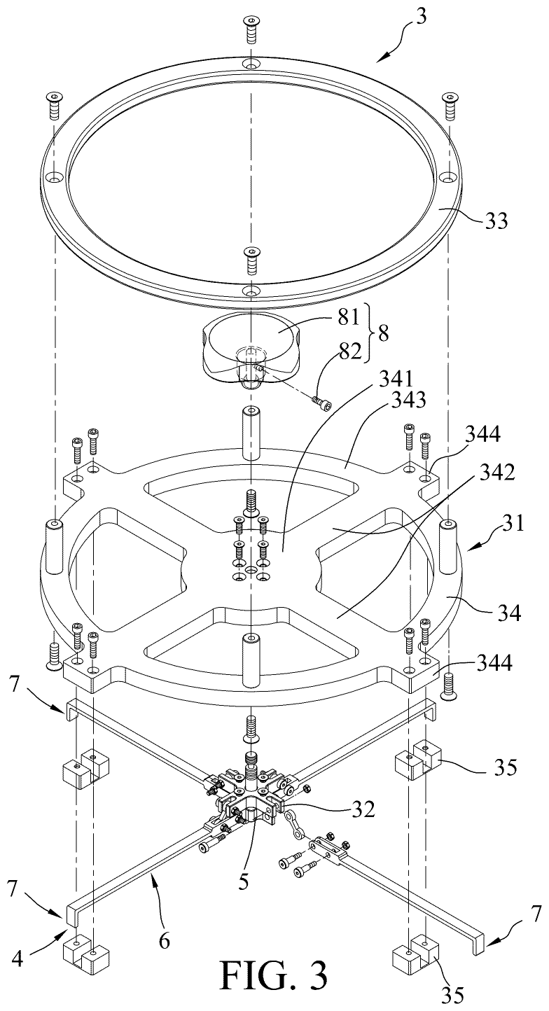

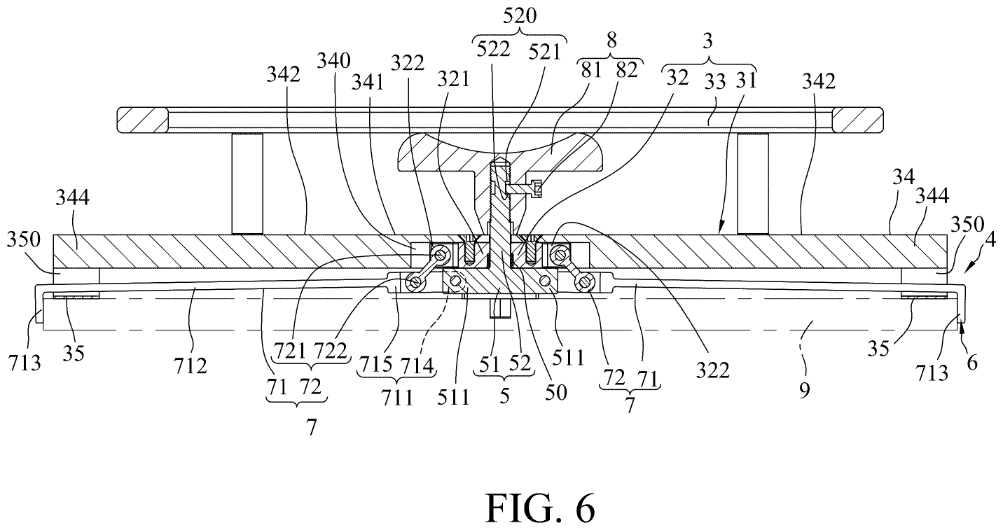

FIGS. 1 to 3 illustrate a clamping device according to an embodiment of the disclosure adapted for clamping a disc-shaped object 9 (see FIG. 6). In the embodiment, the disc-shaped object 9 is exemplified as, but is not limited hereto, a circular fixture. In other embodiments, the disc-shaped object 9 may be a tool or a device required in a manufacturing process. The clamping device of the disclosure includes a seat mechanism 3, an operating unit 8, and a clamping 10 mechanism 4.

The seat mechanism 3 includes a base seat unit 31, a fixed seat 32, and a grasping member 33.

The base seat unit 31 includes a seat body 34 and a plurality of abutment seats 35.

The seat body 34 includes a central portion 341, a plurality of arm portions 342, and an annular portion 343. The central portion 341 is substantially circular and has an accommodation space 340 that opens downwardly. The plurality of arm portions 342 extend outwardly from the central portion 34 and are angularly spaced apart from each other. The annular portion 343 is spaced apart from the central portion 341 and is connected to the plurality of arm portions 342. The plurality of abutment seats 35 are disposed under and connected to the seat body 34. Each of the plurality of abutment seats 35 cooperates with the seat body 34 to define an extension space 350 therebetween. In this embodiment, each of the plurality of arm portions 342 has an arm end 344 that is distal from the central portion 341. The plurality of abutment seats 35 are respectively disposed under and connected to the arm ends 344 of the plurality of arm portions 342. Each of the plurality of abutment seats 35 has a U-shaped cross section and opens upwardly. The extension space 350 is defined between a respective one of the plurality of abutment seats 35 and the arm end 344 of a respective one of the plurality of arm portions 342, and extends in a lengthwise direction of the respective one of the plurality of arm portions 342.

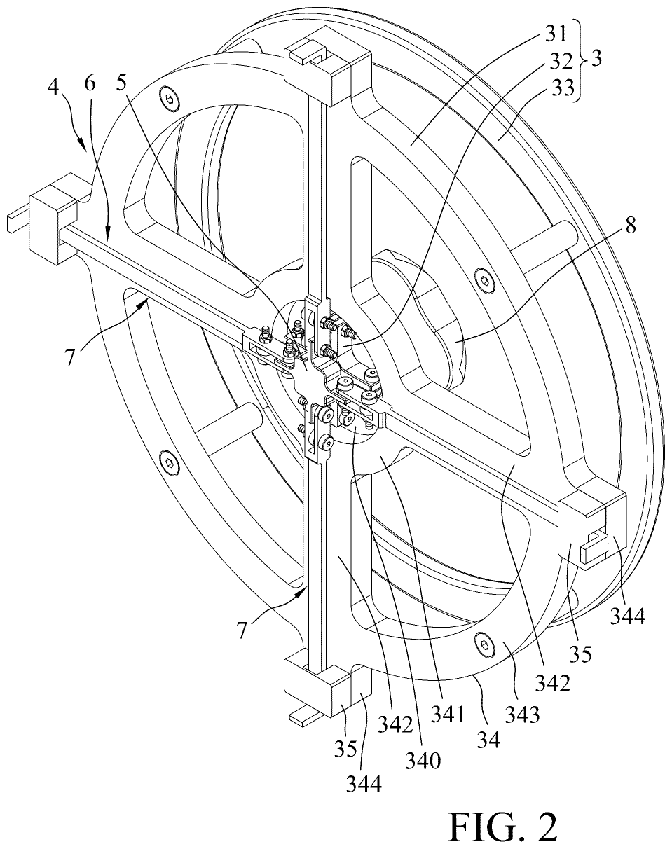

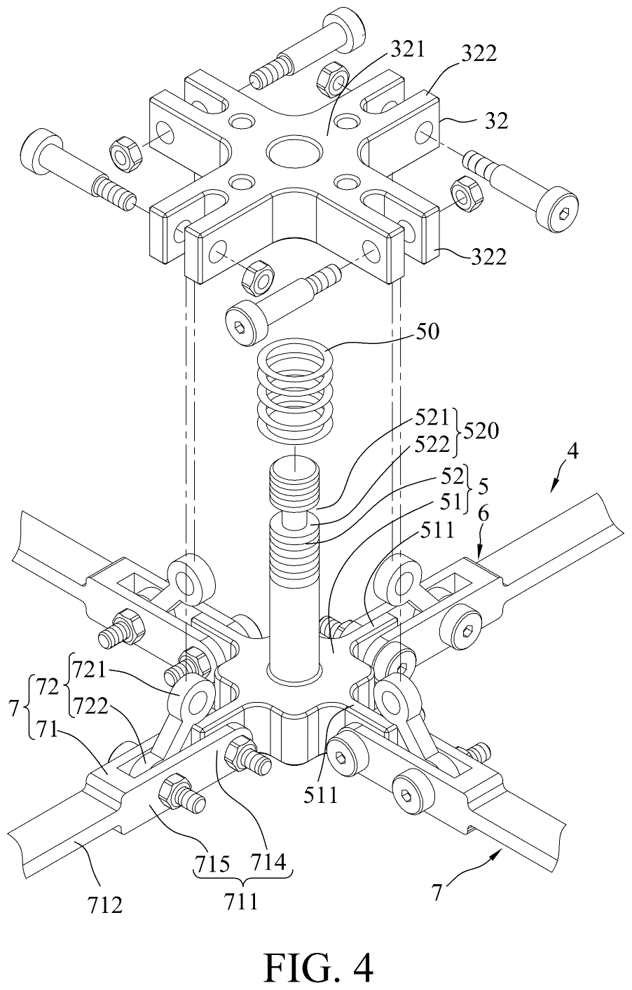

As shown in FIGS. 2, 3, and 4, the fixed seat 32 is disposed under and fixed to the seat body 34. In this embodiment, the accommodation space 340 of the seat body 34 accommodates the fixed seat 32. The fixed seat 32 has a fixed seat body 321, and a plurality of installation portions 322 that extend outwardly from the seat body 321. Each of the plurality of installation portions 322 extends in the lengthwise direction of the respective one of the plurality of arm portions 342.

The grasping member 33 is disposed in a spaced-apart manner above the annular portion 343 of the seat body 34 and is fastened to the annular portion 343 by a plurality of fasteners. In this embodiment, the grasping member 33 has a circular form. However, the form of the grasping member 33 is not limited hereto as long as the grasping member 33 may perform grasping.

The clamping mechanism 4 includes a movable seat 5, a resilient member 50, and a clamping module 6.

The movable seat 5 has an installation portion 51 disposed under and spaced apart from the fixed seat 32 of the seat mechanism 3, and a shaft portion 52 extending upwardly through the fixed seat 32 and the central portion 341 of the seat body 34.

The installation portion 51 of the movable seat 5 has a plurality of installation segments 511 that are respectively disposed under the installation portions 322 of the fixed seat 32.

The shaft portion 52 of the movable seat 5 has a distal end segment extending outwardly of the central portion 341 of the seat body 34, and an adjustment space 520 that is annular and that is formed on an outer surface of the distal end segment of the shaft portion 52. The adjustment space 520 has a top region 521 and a bottom region 522 that is disposed under the top region 521.

The resilient member 50 is sleeved on the shaft portion 52 of the movable seat 5 and has two opposite ends respectively abutting against the installation portion 51 and the fixed seat 32 for biasing resiliently the installation portion 51 of the movable seat 5 away from the fixed seat 32.

The clamping module 6 includes a plurality of clamping units 7 pivotally connected to the seat mechanism 3 and the movable seat 5. The plurality of clamping units 7 are angularly spaced apart from each other and extending outwardly from the movable seat 5. In this embodiment, the plurality of clamping units 7 are pivotally connected to the installation portions 322 of the fixed seat 32 and the installation segments 511 of the installation portion 51 of the movable seat 5.

Each of the plurality of clamping units 7 includes a clamping member 71 and a linkage member 72.

The clamping member 71 of each of the plurality of clamping units 7 extends outwardly from the movable seat 5, and is upwardly and downwardly pivotable relative to the movable seat 5. In this embodiment, the clamping member 71 of each of the plurality of clamping units 7 is pivotally connected to a respective one of the installation segments 511 of the installation portion 51 of the movable seat 5, and extends outwardly in the lengthwise direction of the respective one of the plurality of arm portions 342. The clamping member 71 of each of the plurality of clamping units 7 has a pivotal portion 711, an elongated portion 712, and a clamping portion 713. The pivotal portion 711 is pivotally connected to the respective one of the installation segments 511 of the installation portion 51 of the movable seat 5, and is upwardly and downwardly pivotable relative to the respective one of the installation segments 511 of the installation portion 51 of the movable seat 5. The elongated portion 712 extends from the pivotal portion 711 through the extension space 350 defined between the seat body 34 and the respective one of the plurality of abutment seats 35. The clamping portion 713 extending downwardly from a distal end of the elongated portion 712 that is opposite to the pivotal portion 711 and is distal from the movable seat 5.

For each of the plurality of clamping units 7, the pivotal portion 711 of the clamping member 71 has a first pivotal segment 714 that is pivotally connected to the respective one of the installation segments 511 of the installation portion 51 of the movable seat 5, and a second pivotal segment 715 that interconnects the first pivotal segment 714 and the elongated portion 712.

In this embodiment, for each of the plurality of clamping units 7, the clamping member 71 is designed to be one-piece in structure. However, in other embodiments, the clamping member 71 may be designed to have two parts that are connected to each other and that extend in the lengthwise direction of the respective one of the plurality of arm portions 342.

The linkage member 72 of each of the plurality of clamping units 7 has a first linkage end 721 pivotally connected to the seat mechanism 3, and a second linkage end 722 opposite to the first linkage end 721 and pivotally connected to the clamping member 71. In this embodiment, the first linkage end 721 is pivotally connected to a respective one of the installation portions 322 of the fixed seat 32. The second linkage end 722 is pivotally connected to the second pivotal segment 715 of the pivotal portion 711 of the clamping member 71. The linkage member 72 may drive the clamping member 71 to pivotally move relative to the movable seat 5.

The operating unit 8 is disposed on the seat mechanism 3. The movable seat 5 is connected to the operating unit 8. In this embodiment, the operating unit 8 includes an operating member 81 that is threadedly connected to the distal end segment of the shaft portion 52 of the movable seat 5, and a limiting member 82 that threadedly engages the operating member 81 and that extends into the adjustment space 520 of the shaft portion 52.

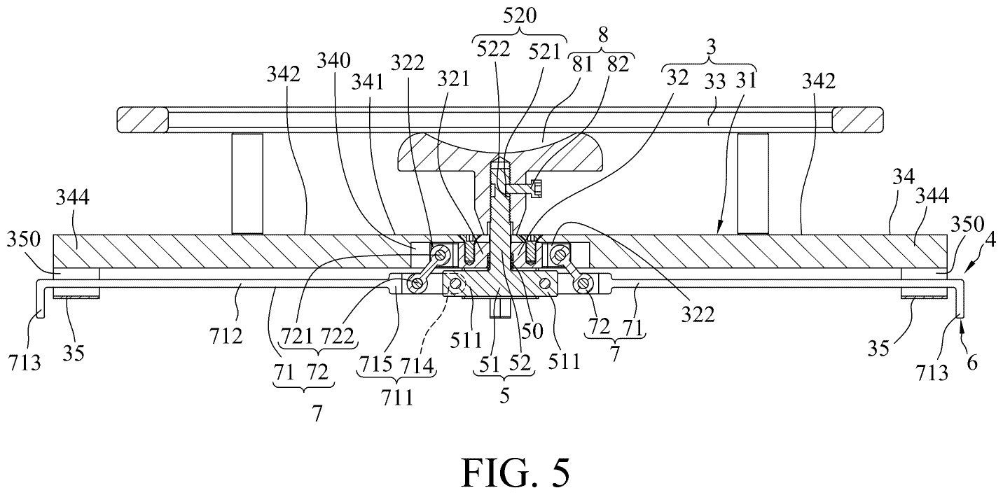

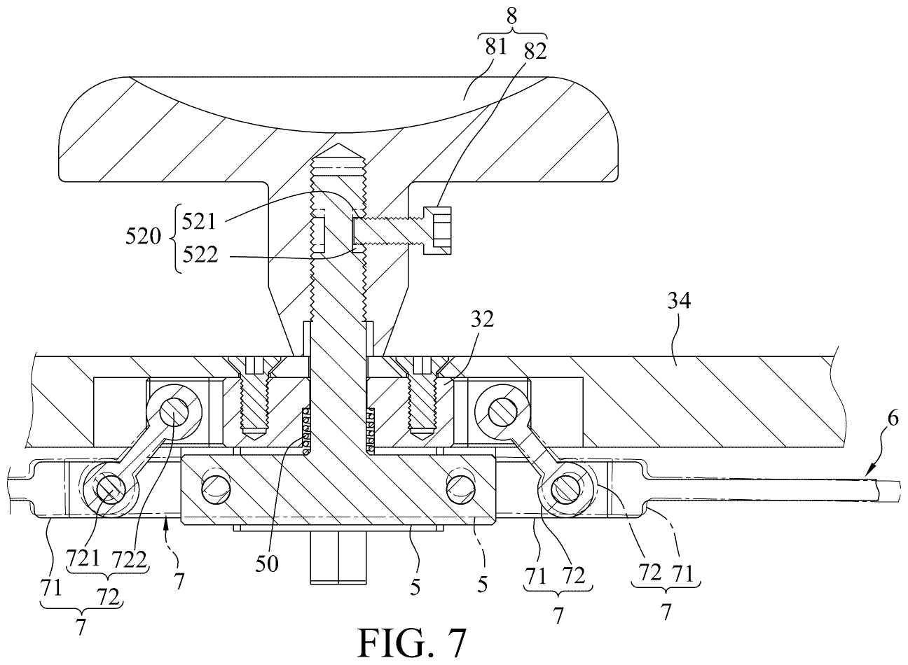

Referring to FIGS. 5, 6, and 7, in practice, the grasping member 33 is first being held such that the abutment seats 35 abut against the disc-shaped object 9. The operating unit 8 is operable and rotatable relative to the seat body 34 for driving the clamping mechanism 4 to move relative to the seat mechanism 3 between a release position (see FIG. 5), where the clamping units 7 are adapted to release the disc-shaped object 9 therefrom, and a clamping position (see FIG. 6), where the clamping units 7 are adapted to clamp the disc-shaped object 9.

When the clamping mechanism 4 is in the release position, the pivotal portion 711 and the elongated portion 712 of the clamping member 71 of each of the plurality of clamping units 7 are substantially horizontal, and the limiting member 82 is in the top region 521 of the adjustment space 520. During movement of the clamping mechanism 4 from the release position to the clamping position as the operating unit 8 rotates relative to the seat body 34, the movable seat 5 is moved upwardly relative to the fixed seat 32, and the shaft portion 52 is moved upwardly relative to the limiting member 82. When the clamping mechanism 4 is in the clamping position, the limiting member 82 is in the bottom region 522 of the adjustment space 520 so the operating unit 8 is not allowed to be operated to rotate.

During movement of the clamping mechanism 4 from the release position to the clamping position, the movable seat 5 is moved upwardly relative to the seat mechanism 3, thereby driving the clamping portions 713 of the plurality of clamping units 7 to move toward each other to clamp the disc-shaped object 9. In this embodiment, during movement of the clamping mechanism 4 from the release position to the clamping position, the upward movement of the movable seat 5 drives the first pivotal segment 714 of the pivotal portion 711 of the clamping member 71 of each of the plurality of clamping units 7 to move upwardly, such that the clamping member 71 of each of the plurality of clamping units 7 is pivoted downwardly relative to the movable seat 5. Meanwhile, because the second linkage end 722 of the linkage member 72 is pivotally connected to the second pivotal segment 715 of the pivotal portion 711 of the clamping member 71 of each of the plurality of clamping units 7, the elongated portion 712 of the clamping member 71 is pivoted downwardly about a fulcrum formed by a junction of the second pivotal segment 715 and the second linkage end 722, thereby driving the clamping portions 713 of the plurality of clamping units 7 to move toward each other and driving ends of the clamping portions 713 of the plurality of clamping units 7 to be oriented slightly and respectively toward the plurality of abutment seats 35 to clamp the disc-shaped object 9. That is to say, for each of the plurality of clamping units 7, the pivotal portion 711 of the clamping member 71 is driven by the upward movement of the movable seat 5 and abuts against the linkage member 72 such that the elongated portion 712 of the clamping member 71 is substantially downwardly inclined. As a result, the clamping portions 713 of the plurality of clamping units 7 are driven to move toward each other and the ends of the clamping portions 713 of the plurality of clamping units 7 are oriented slightly and respectively toward the plurality of abutment seats 35, so that the disc-shaped object 9 is clamped and the clamping mechanism 4 is in the clamping position.

To release the disc-shaped object 9, the clamping mechanism 4 is driven by rotating of the operating unit 8 to move from the clamping position to the release position. During movement of the clamping mechanism 4 from the clamping position to the release position, the movable seat 5 is moved downwardly relative to the fixed seat 32 of the seat mechanism 3, thereby driving the clamping portions 713 of the plurality of clamping units 7 to move away from each other to release the disc-shaped object 9.

It should be noted that the two opposite ends of the resilient member 50 respectively abut against the installation portion 51 and the fixed seat 32. During movement of the clamping mechanism 4 from the release position to the clamping position, the resilient member 50 is compressed to have a resilient force. During movement of the clamping mechanism 4 from the clamping position to the release position, the resilient force of the resilient member 50 resiliently biases the installation portion 51 of the movable seat 5 away from the fixed seat 32 and the seat body 34, thereby facilitating a smooth operation of the operating unit 8.

In this embodiment, the quantity of the clamping units 7 is four. In other embodiments, the quantity of the clamping units 7 may be two, three, or more than four.

In this embodiment, because the operating member 81 of the operating unit 8 is threadedly connected to the distal end segment of the shaft portion 52, the movable seat 5 is moved upwardly and downwardly relative to the seat mechanism 3 by rotating of the operating unit 8. However, as long as the movable seat 5 is moved upwardly and downwardly relative to the seat mechanism 3 by rotating of the operating unit 8, it is not limited that the operating member 81 of the operating unit 8 is threadedly connected to the distal end segment of the shaft portion 52.

In summary, by virtue of the operating unit 8 being operable for driving the clamping mechanism 4 to move relative to the seat mechanism 3 between the release position and the clamping position, a user may use the clamping device of the disclosure to clamp the disc-shaped object 9 so as to avoid contacting chemicals and reduce the risk of dropping the disc-shaped object 9 taken by bare hands.

Furthermore, because for each of the plurality of clamping units 7, the clamping member 71 is pivotally connected to the movable seat 5 and the linkage member 72 is pivotally connected between the fixed seat 32 and the clamping member 71, the clamping members 71 of the plurality of clamping units 7 are driven by the upward movement of the movable seat 5 and pulling forces of the linkage members 72 of the plurality of clamping units 7 such that the ends of the clamping portions 713 of the plurality of clamping units 7 are oriented slightly and respectively toward the plurality of abutment seats 35.

Moreover, because the limiting member 82 extends into the adjustment space 520 of the shaft portion 52 of the movable seat 5, and because the shaft portion 52 is movable relative to the limiting member 82, the upward and downward movements of the movable seat 5 may be intuitively controlled by operation of the operating unit 8.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A clamping device adapted for clamping a disc-shaped object, said clamping device comprising:
a seat mechanism;
an operating unit disposed on said seat mechanism; and
a clamping mechanism including
a movable seat that has an installation portion disposed under and spaced apart from said seat mechanism, and a shaft portion extending upwardly through said seat mechanism, said movable seat being connected to said operating unit, and
a clamping module that includes a plurality of clamping units pivotally connected to said seat mechanism and said movable seat, said plurality of clamping units being angularly spaced apart from each other and extending outwardly from said movable seat, each of said plurality of clamping units having a clamping portion that is distal from said movable seat;
wherein said operating unit is operable for driving said clamping mechanism to move relative to said seat mechanism between a release position, where said clamping units are adapted to release the disc-shaped object therefrom, and a clamping position, where said clamping units are adapted to clamp the disc-shaped object; and
wherein, during movement of said clamping mechanism from the release position to the clamping position, said movable seat is moved upwardly relative to said seat mechanism, thereby driving said clamping portions of said plurality of clamping units to move toward each other to clamp the disc-shaped object.

2. The clamping device as claimed in claim 1, wherein each of said plurality of clamping units includes
a clamping member that extends outwardly from said movable seat, that is upwardly and downwardly pivotable relative to said movable seat, and that has said clamping portion, and
a linkage member that has a first linkage end pivotally connected to said seat mechanism, and a second linkage end opposite to said first linkage end and pivotally connected to said clamping member.

3. The clamping device as claimed in claim 2, wherein:
said seat mechanism includes
a base seat unit including
a seat body, and
a plurality of abutment seats that are disposed under and connected to said seat body, each of said plurality of abutment seats cooperating with said seat body to define an extension space therebetween, and
a fixed seat disposed under and fixed to said seat body;
said first linkage end of said linkage member of each of said plurality of clamping units is pivotally connected to said fixed seat; and
said clamping member of each of said plurality of clamping units extends through said extension space defined between said seat body and a respective one of said plurality of abutment seats.

4. The clamping device as claimed in claim 3, wherein:
said clamping member of each of said plurality of clamping units has said clamping portion, and further has
a pivotal portion that is pivotally connected to said movable seat, and
an elongated portion that extends from said pivotal portion through said extension space defined between said seat body and said respective one of said plurality of abutment seats, said clamping portion extending downwardly from a distal end of said elongated portion that is opposite to said pivotal portion; and
for each of said plurality of clamping units, said second linkage end of said linkage member is pivotally connected to said pivotal portion of said clamping member.

5. The clamping device as claimed in claim 4, wherein:
said pivotal portion of said clamping member of each of said plurality of clamping units is pivotally connected to said installation portion of said movable seat;
said shaft portion of said movable seat extends upwardly from said installation portion through said fixed seat and said seat body of said base seat unit, and has a distal end segment connected threadedly to said operating unit, such that said operating unit is rotatable relative to said seat body to drive said clamping mechanism to move between the release position and the clamping position;
during movement of said clamping mechanism from the release position to the clamping position, said movable seat is moved upwardly relative to said fixed seat of said seat mechanism, thereby driving said clamping portions of said plurality of clamping units to move toward each other; and
during movement of said clamping mechanism from the clamping position to the release position, said movable seat is moved downwardly relative to said fixed seat of said seat mechanism, thereby driving said clamping portions of said plurality of clamping units to move away from each other.

6. The clamping device as claimed in claim 5, wherein:
said shaft portion of said movable seat has an adjustment space that is annular and that is formed on an outer surface of said distal end segment of said shaft portion, said adjustment space having a top region and a bottom region that is disposed under said top region;
said operating unit includes
an operating member that is threadedly connected to said distal end segment of said shaft portion, and
a limiting member that threadedly engages said operating member and that extends into said adjustment space;
when said clamping mechanism is in the release position, said limiting member is in said top region of said adjustment space;
during movement of said clamping mechanism from the release position, said shaft portion is moved upwardly relative to said limiting member; and
when said clamping mechanism is in the clamping position, said limiting member is in said bottom region of said adjustment space.

7. The clamping device as claimed in claim 4, wherein, for each of said plurality of clamping units:
said pivotal portion of said clamping member has
a first pivotal segment that is pivotally connected to said movable seat, and
a second pivotal segment that interconnects said first pivotal segment and said elongated portion; and
said second linkage end of said linkage member is pivotally connected to said second pivotal segment of said pivotal portion.

8. The clamping device as claimed in claim 3, wherein said seat body has an accommodation space that opens downwardly and that accommodates said fixed seat.

9. The clamping device as claimed in claim 8, wherein:
said seat body includes
a central portion that has said accommodation space,
a plurality of arm portions that extend outwardly from said central portion and that are angularly spaced apart from each other, and
an annular portion that is spaced apart from said central portion and that is connected to said plurality of arm portions; and
said plurality of abutment seats are respectively disposed under and connected to said plurality of arm portions.

10. The clamping device as claimed in claim 5, wherein said clamping mechanism further includes a resilient member that is sleeved on said shaft portion of said movable seat and that has two opposite ends respectively abutting against said installation portion and said fixed seat for biasing resiliently said installation portion of said movable seat away from said fixed seat.

11. The clamping device as claimed in claim 4, wherein said seat body has an accommodation space that opens downwardly and that accommodates said fixed seat.
